(19) United States
(12) Patent Application Publication
(10) Pub. No.: US 2024/0183744 A1
(43) Pub. Date: Jun. 6, 2024

(54) REAL-TIME FEED PIPE MONITORING

(71) Applicant: X Development LLC, Mountain View, CA (US)

(72) Inventors: Thomas Robert Swanson, Sunnyvale, CA (US); Harrison Pham, Sunnyvale, CA (US)

(21) Appl. No.: 18/531,243

(22) Filed: Dec. 6, 2023

Related U.S. Application Data
(60) Provisional application No. 63/430,534, filed on Dec. 6, 2022.

(51) Int. Cl. G01M 5/00; A01K 61/80; A01K 63/00; G01M 3/16; G01M 3/18

(52) U.S. Cl. CPC G01M 5/0091; A01K 61/80; A01K 63/003; G01M 3/165; G01M 3/18; G01M 5/0025

(57) ABSTRACT

Methods, systems, and apparatus, including computer programs encoded on computer storage media, for real-time monitoring of an aquaculture feeding system using Time Domain Reflectometry (TDR). In one aspect, an aquaculture feeding system comprises: a feed pipe arranged between a dosing system and a fish pen; a feed pipe monitoring subsystem comprising one or more controlled impedance cables arranged along the feed pipe, and a pulse generator configured to generate a series of pulses at a predetermined pulse rate to be transmitted through the controlled impedance cables; and a controller subsystem connected to the feed pipe monitoring subsystem, the controller subsystem configured to: monitor pulse responses along the controlled impedance cables; and detect, from the pulse responses, a condition of the feed pipe.

### CROSS-REFERENCE TO RELATED APPLICATIONS

This application claims the benefit of the filing date of U.S. Provisional Patent Application Ser. No. 63/430,534 for “REAL-TIME FEED PIPE MONITORING,” which was filed on Dec. 6, 2022, and which is incorporated here by reference in its entirety.

### FIELD

This specification relates to a real-time monitoring system for aquaculture feeding systems.

### BACKGROUND

Aquaculture involves the farming of aquatic organisms, such as fish, crustaceans, or aquatic plants. In aquaculture, and in contrast to commercial fishing, freshwater and saltwater fish populations are cultivated in controlled environments. For example, the farming of fish can involve raising fish in tanks, fish ponds, or ocean enclosures. Farming aquaculture livestock typically requires that the livestock be fed while the livestock grows. For example, salmon being farmed may be fed for three to seven hours a day until the salmon are large enough to be harvested. An automated feeding system can be used to feed the livestock with food that is transmitted through a feed pipe. A feed pipe abnormality, such as a clog breakage that is present in the feed pipe, may not only result in food waste but also affect the growth rate of the farmed fish.

### SUMMARY

In general, innovative aspects of the subject matter described in this specification relate to real-time monitoring of an aquaculture feeding system using Time Domain Reflectometry (TDR). A system that provides real-time monitoring of an aquaculture feeding system can quickly detect any disruption or interruption in a feed pipe, initiate actions that minimize equipment damage and feed waste in the feeding system. For example, through the use of such a system, it is possible to determine not only the presence of a clog in the feed pipe, but also its exact location within the feed pipe (which may be hundreds or thousands of feet in length and at least partially underwater), so as to assist a maintenance crew to more effectively unclog the feed pipe to minimize downtime of the feeding system and ensure efficiency in farming aquatic livestock.

One innovative aspect of the subject matter described in this specification is embodied in aquaculture feeding system comprising: a feed pipe arranged between a dosing system and a fish pen; a feed pipe monitoring subsystem comprising one or more controlled impedance cables along the feed pipe, and a pulse generator configured to generate a series of pulses at a predetermined pulse rate to be transmitted through the controlled impedance cables; and a controller subsystem connected to the feed pipe monitoring subsystem, the controller subsystem configured to: monitor pulse responses along the controlled impedance cables; and detect, from the pulse responses, a condition of the feed pipe.

Other implementations of this and other aspects include corresponding methods comprising the operations performed by the system and computer programs recorded on one or more computer storage devices, each configured to perform the actions of the methods. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination.

Detecting the condition of the feed pipe may comprise detecting an abnormality in the feed pipe.

Detecting the fault in the feed pipe may comprise detecting a location or a type of the abnormality in the feed pipe.

The type of the abnormality in the feed pipe may comprise a leakage, a clog, or a breakage of the feed pipe.

The pulse generator may comprise a Time Domain Reflectometry (TDR) pulse generator that is configured to generate TDR pulses.

Monitoring the pulse responses along the controlled impedance cables may comprise: monitoring time domain TDR pulse responses of the controlled impedance cables; and determining a voltage level change in the time domain TDR pulse responses.

Detecting the condition of the feed pipe may comprise: obtaining a first Time Domain Reflectometry (TDR) pattern of the feed pipe; and detecting the condition by comparing the first TDR pattern with a second TDR pattern that indicates an expected TDR pattern for a feed pipe without any abnormalities.

Monitoring the pulse responses along the controlled impedance cables may comprise: performing simultaneous analog-to-digital sampling of the pulse responses.

Monitoring the pulse responses along the controlled impedance cables may comprise: performing dynamic spatial resolution modification of the pulse responses.

The one or more controlled impedance cables may comprise one or more twin-lead cables.

The controller subsystem may also be configured to determine, from the pulse responses, one or more of the following: underwater motion of the feed pipe; density of feed in the feed pipe; velocity of the feed moving along the feed pipe; or estimate of an amount of feed to be delivered to the enclosure.

The controller subsystem may also be configured to transmit a message to the dosing system as a result of detecting the condition.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1 depicts an example feeding system and enclosures that each contain aquatic livestock from above.

FIG. 2 depicts an example monitoring system.

FIG. 3 is a flow diagram for an example process of monitoring a feeding system.

FIGS. 4A-C depict example Time-Domain Reflectometry (TDR) plots of pulse responses as a function of time for three different conditions of the feeding system.

Like reference numbers and designations in the various drawings indicate like elements.

### DETAILED DESCRIPTION

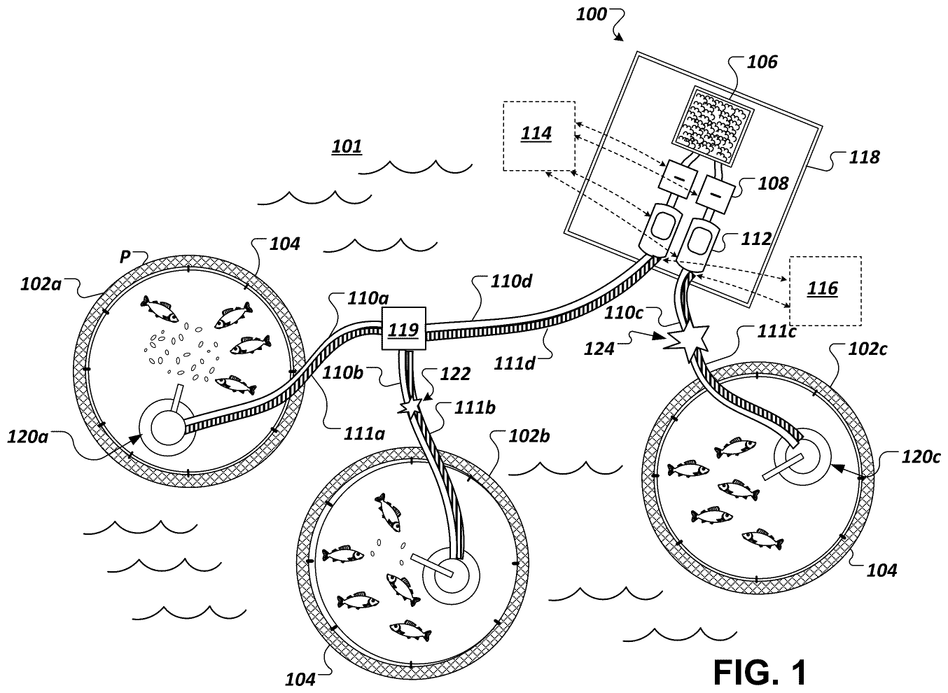

FIG. 1 depicts an example feeding system 100 and enclosures 102a-102c that each contain aquatic livestock from above. The livestock 104 can be aquatic creatures, such as fish that swim freely within the confines of the enclosure 102a-102c. In some implementations, the aquatic livestock 104 held within the enclosures 102a-102c can include finfish or other aquatic lifeforms. The livestock 104 can include for example, juvenile fish, koi fish, sharks, salmon, and bass, to name a few examples. In addition to the aquatic livestock, each enclosure 102a-102c contains water, e.g., seawater, freshwater, or rainwater, although the enclosure can contain any fluid that is capable of sustaining a habitable environment for the aquatic livestock.

The feeding system 100 includes feed storage 106, a dosing system 108, feed pipes 110a-110d that are connected to the respective enclosures 102a-102c, one or more blowers 112, a controller 114, and a monitoring system 116. The feeding system 100 can be used to feed aquatic livestock 104 according to a feeding protocol or schedule. In order to feed the livestock 104, the controller 114 instructs the dosing system 108 to transfer a quantity of feed from the feed storage 106 to a respective feed pipe 110a-110d. The controller 114 then instructs the blower 112 to blow air along the feed pipe 110a-110d to convey the feed along the pipe 110a-110d and to the enclosure 102a-102c.

Farmed fish can be fed dried pellets of food that are specially adapted to the nutritional needs of each species of fish. The feed storage 106 can be a silo or container that holds a large quantity of such feed pellets. In automated systems, the silo often has an opening at the bottom that connects to the dosing system 108. The dosing system 108 loads the pellets into the feed pipes 110a-110d by weight or volume. For example, the dosing system 108 can include an auger screw. The blowers 112 are connected to the feed pipes 110a-110d and pressurize air that moves the pellets along the feed pipes 110a-110d.

The controller 114 can be a programmable logic controller (PLC), a computing device (e.g., desktop, laptop, tablet, mobile computing device, server or otherwise), or other form of controller that implements control logic to automatically generate instructions for controlling a feed rate of the dosing system 108, a flow rate of the blowers 112, or both and possibly additional operational parameters of other components of the feeding system 100 based on signals from these components. The controller 114 can be communicatively coupled to another system, e.g., a server or a user device, over a wired or wireless network, and can receive commands or other networked communications from the other system, so as to implement a given feeding protocol that is stored at the other system.

The enclosures 102a-102c can be large circular pens (“fish pens”) that have a diameter of approximately 40 meters (131.2 feet), for example. The pens are arranged in a large body of water 101, such as the ocean, and connected to a feed barge 118 by the feed pipes 110a-110d. The total length of the feed pipes 110a-110d can range from, e.g., 100 to 500 meters (328 feet to 1640 feet), 500 to 1000 meters (1640 to 3281 feet), or 1000 to 2000 meters (3280 feet to 6561 feet). The feed pipes 110a-110d can be located underwater (e.g., at 1-5 feet below the water surface), at the surface of the expanse of water, or partially underwater and partially at the surface of the expanse of water. In some cases, a selector or switch 119 is used to connect multiple enclosures to a common blower 112 or section of feed pipe 110d. Although the switch 119 is schematically depicted between the feed barge 118 and the enclosures 102a, 102b in FIG. 1, the switch 119 can also be located on the feed barge 118.

A first enclosure 102a includes a spreader 120a that is connected to the end of a first feed pipe 110a. The spreader 120 distributes a cloud of pellets that traveled through the feed pipes 110a, 110d within the first enclosure 102a. The livestock 104 are shown feeding on the pellets. The first enclosure 102a shows the components of the feeding system 100 working as intended in a normal condition.

A second enclosure 102b is connected to the feeding system 100 by a second feed pipe 110b that has a clog (or blockage) 122 along the length of the second feed pipe 110b. In some cases, the feed pellets can include fish oil or other ingredients that sticks to the inner walls of the feed pipes 110a-110d, which can have a small cross-sectional area relative to their length. For example, the feed pipes 110a-110d can have an outer diameter that ranges from 20 to 150 mm (0.8 to 5.9 inches) and a length of over 3000 feet. The feed pipes 110a-110d are especially prone to clogging when the temperature increases. As another example, clogging of a feed pipe may occur if a piece of debris enters the feed pipe and becomes lodged inside. As yet another example, clogging may occur if there exists a mismatch between the settings of the dosing system 108 and the blowers 112, e.g., when the air amount blown by the blowers 112 along the feed pipe is insufficient to convey the cloud of pellets thoroughly through the feed pipe. A clog 122 in the feed pipe 110b will prevent some or all of the intended feed from reaching the second enclosure 102b. If the clog 122 is not quickly detected and remedied, the livestock 104 may miss one or more feeding cycles, disrupting the livestock's growth. In some cases, a clog 122 in the feed pipe 110b may also cause damage to the equipment of the feeding system 100.

A third enclosure 102c is connected to the feeding system 100 by a third feed pipe 110c. Like the second feed pipe 110b, the third feed pipe 110c has a clog (or blockage) 124 along the length of the third feed pipe 110c. In the example of FIG. 1, while the clog 122 in the second feed pipe 110b is a small (or partial) clog that prevents some pellets from arriving at the enclosure 102b (thus affecting the overall feed volume), the clog 124 in the third feed pipe 110c is a large (or complete) clog that results in complete obstruction in the path for the feed pipe to flow. The first enclosures 102b and 102c thus show the components of the feeding system 100 working as unintended in an abnormal condition.

Given the typical length (and diameter) of a feed pipe that transports feed pellets between a feed storage and one or more enclosures, knowing the exact location of a clog within the feed pipe should this clog occur, is difficult. Adding to this difficulty is the open ocean environment in which the feed pipe is located. The feeding system 100 thus includes a monitoring system 116 that facilitates real-time monitoring of the latest condition (which includes the locations of any clogs in the feeding pipes) of the feeding system.

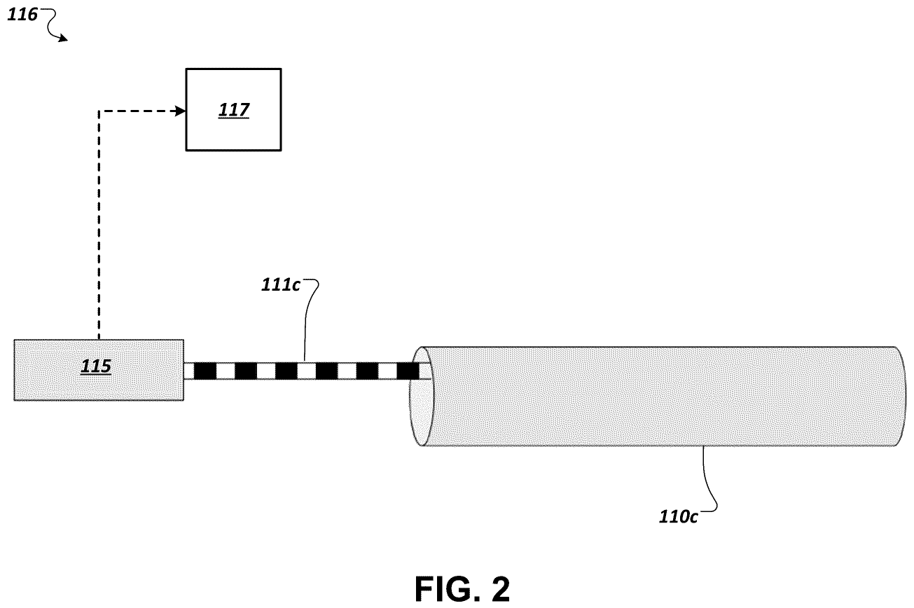

FIG. 2 depicts an example monitoring system, e.g., the monitoring system 116 in the feeding system 100 of FIG. 1. The monitoring system 116 can be implemented using one or more controlled impedance cables 111a-d, a time domain reflectometer (TDR) pulse transceiver 115, and an oscilloscope 117. The TDR pulse transceiver 115 includes a pulse generator module configured to generate a series of voltage pulses at a predetermined pulse rate to be transmitted through the controlled impedance cable which, when bounced back, will be received by a pulse receiver module of the TDR pulse transceiver 115. The voltage pulses are then measured with the oscilloscope 117 which is connected to the TDR pulse transceiver 115. A core difference between TDR and other frequency domain analysis methods is its focus in the time domain, i.e., instead of the frequency domain where some parameters such as voltage signal travel time are difficult to be derived back out of. This means that it is capable of measuring the travel time for a voltage signal to reach the end of a controlled impedance cable, or a clog somewhere along the feed pipe, and bounce back to its entry point.

Specialized equipment can be used that combine a pulse generator and a sampling oscilloscope, which are optimized for periodic measurements. However, specialized equipment is not always required. In addition, some implementations of the monitoring system 116 can replace the TDR pulse transceiver 115, the oscilloscope 117, or both with a digital signal processor having similar functions. Key pulse parameters, including the amplitude and width of a voltage pulse, can be calibrated and tuned (e.g., periodically as required) to each specific system and specific monitoring requirements in order to capture the desired measurement data.

Each controlled impedance cable has one or more center conductors. As one example of such a controlled impedance cable, a coaxial cable has a center conductor surrounded by a dielectric (and optionally with a ground reference shield outside the dielectric and further optionally a sheath covering the shield). As another example, a twin-axial cable has two center conductors surrounded by a dielectric. As yet another example, a ladder line (sometimes also called twin-lead or open-wire line) has two parallel conductors separated by an insulator, either plastic or simply the air itself.

At one end, the controlled impedance cable, e.g., controlled impedance cable 111c, can be connected to the TDR pulse transceiver 115 of the monitoring system 116. The other end of the controlled impedance cable can be the termination of a feed pipe, e.g., where the feed pipe 110c connects to the spreader 120c.

The controlled impedance cable can span an entire length of the feed pipe which can be as long as 1500 feet, 3000 feet, or more. In the example of FIG. 2, the controlled impedance cable 111c can span an entire length of feed pipe 110c of the feeding system 100. In some cases, the controlled impedance cable can move freely within the feed pipe while in other cases, the controlled impedance cable is fixed, e.g., clamped, to an inside surface of the feed pipe to prevent slippage. Moreover, in those other cases, the controlled impedance cable can be fixed in a particular pattern, e.g., wrapped around the inner wall of the feed pipe in a circular pattern, to facilitate three-dimensional measurements.

Working in tandem with the monitoring system 116, the controller 114 can determine a latest condition of the feeding system 100 because TDR allows for characterizing and localizing clogs or other abnormalities in a feed pipe, along which one or more controlled impedance cables are positioned. Generally, the controller 114 is configured to determine the latest condition of the feeding system 100 based on waveforms of voltage pulses measured by the oscilloscope 117 that is in data communication with the controller 114. The controller 114 can monitor and determine the condition of the feeding system 100 automatically. That is, the controller 114 does not require human evaluation or input to determine whether and if so where a clog or another abnormality occurs in a feed pipe of the feeding system 100.

A number of actions can then be triggered as a result of detecting the condition, e.g., following the determination of the location of a clog, should the clog occur in the feed pipe. In various examples, the controller 114 could send instructions to the blower 112 to blow an increased air amount helping to blow the clog out; the controller 114 could send instructions to the dosing system 108 to temporarily halt the loading of the pellets into the feed pipe; the controller 114 could generate instructions to deploy a cleaning device (e.g., that uses soft robotics technology) in the feed pipe for removal of the clog; the controller 114 could also generate and provide for display on the computer or user device communicatively coupled to the controller 114 an indication for the need to dispatch a maintenance crew.

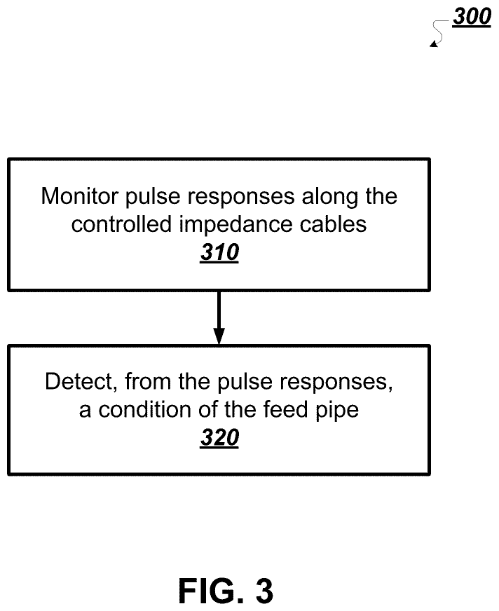

FIG. 3 is a flow diagram for an example process 300 of monitoring a feeding system. The example process 300 may be performed by various systems, including the feeding system 100 of FIG. 1. For example, the process 300 may be performed by the controller 114 described in relation to FIG. 1 to 2.

The process 300 may be repeated as often as necessary to obtain the most recent condition of the feeding system, thereby sends instructions to the dosing system 108, the blower 112, or other components of the feeding system 100 to operate the feeding system in a manner specific to the obtained condition. For example, the process 300 may be repeated once ten minutes, or once an hour, or once a day. The process 300 could also be triggered prior to every feeding cycle so as to ensure there is no abnormality in the feed pipe that will result in disruptions to the feeding cycles.

The process 300 includes using a TDR pulse transceiver of a monitoring system to generate a series of pulses to be transmitted through one or more controlled impedance cables, and monitoring pulse responses along the controlled impedance cables (310). Generally, the controller can monitor the time domain voltage pulse responses of the controlled impedance cables and in particular, any voltage level change in the time domain pulse responses. The controlled impedance cables are arranged along a feed pipe that is arranged between a dosing system and an enclosure of aquatic livestock. The controlled impedance cables facilitate propagation of the voltage pulses that propagate down the feed pipe. When the propagating pulses encounter a material, such as the end of the feed pipe, or a clog somewhere along the feed pipe, some or all of the pulse energy is reflected back into the TDR pulse transceiver. The reflected pulse responses are then measured with an oscilloscope.

The process 300 thus also includes detecting, from the pulse responses monitored by the monitoring system, a condition of the feed pipe (320). Using TDR, and when measured with the oscilloscope, the pulse responses can be represented as waveforms of voltage pulses. The controller can perform automated analysis of the pulse responses to detect the condition of the feed pipe. In some implementations, this can include detecting an abnormality in the feed pipe, including detecting a location of the abnormality, a type (e.g., a leakage, a clog, or a breakage) of the abnormality, or both.

With proper signal processing and advanced analysis techniques (e.g., leveraging machine learning, computer vision, and other data-based methods), it is possible to compare live pulse responses with a stored reference to detect, characterize, and quantify changes, as well as to interpret plots of the waveforms to determine parameters including voltage amplitude, voltage pulse travel time, and so on, that are indicative of the condition of the feed pipe. By way of illustration and not limitation, the controller can obtain a first Time Domain Reflectometry (TDR) pattern of the feed pipe; and detecting the condition of the feed pipe, including detecting any abnormality in the feed pipe, by comparing the first TDR pattern with a second TDR pattern that indicates an expected TDR pattern for a feed pipe without any abnormalities.

A number of equipment and associated techniques can also be used to enhance the effectiveness in the detection of the condition of the feed pipe. For example, the measurement circuitry in the monitoring system can be implemented using an analog-to-digital converter (ADC) which facilitates synchronized sampling. Performing synchronized sampling can improve time resolution of the measurements and increase signal-to-noise ratio.

Traditional ADCs are often run in a free-running mode where they take measurements at fixed time intervals (for example, once every microsecond). Synchronized sampling is a more advanced ADC sampling technique where the measurement time is controlled by a reference clock pulse. This allows the controller 114 to very accurately time the initial measurement (for example, down to the nanosecond, or below).

As another example, the controller can use dynamic spatial resolution to identify regions of interest, e.g., around a particular time point, in the waveform plots and focus measurements within those regions. Dynamic spatial resolution to refer to the ability to use synchronized sampling techniques to change the ADC time resolution as needed in the control algorithms. For example, the controller 114 can use traditional free-running ADC sampling to do an initial scan of the feed pipe. If the controller 114 detects a clog, it may transition the ADCs to a synchronized-sampling control mode where it triggers measurements at exactly the right instant to focus the ADC measurements at certain parts of the waveform. This gives the controller 114 a dynamic time resolution, which translates directly into dynamic spatial resolution.

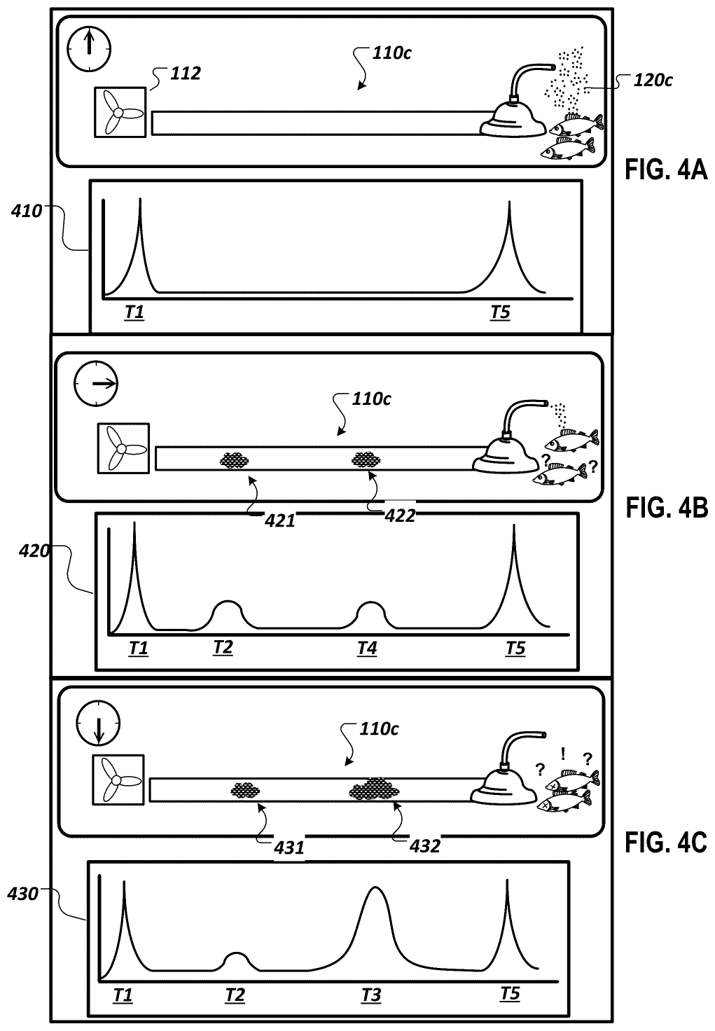

FIGS. 4A-C depict example Time-Domain Reflectometry (TDR) plots of pulse responses as a function of time for three different conditions of the feeding system. In these example plots, the y axis represents voltage (e.g., in millivolts) and the x axis represents time (e.g., in nanoseconds). The plots represent the voltage of the signal path as a function of transit time of the voltage signal. The time is therefore a measure of the longitudinal position along the signal path.

FIG. 4A depicts an example TDR plot for a normal condition of the feeding system. In FIG. 4A, two crests appear at time points T1 and T5, respectively, in the waveform 410. In some cases, the crest at time point T1 has voltage value of 1000 millivolts. In some cases, the crest at time point T5 has voltage value of 900 millivolts. The crest at time point T5 corresponds to a far end reflection that occurs because the voltage pulse that has been transmitted out along the one or more controlled impedance cables at time point T1 is bounced back when it reaches the termination of a feed pipe, where the one or more controlled impedance cables end. For example, the feed pipe can be the feed pipe 110c of FIG. 1 which connects the blower 112 to the spreader 120c.

FIG. 4B depicts an example TDR plot for an abnormal condition of the feeding system. In FIG. 4B, four crests appear at time points T1, T2, T4, and T5, respectively, in the waveform 420. Like FIG. 4A, in some cases, the crest at time point T1 has voltage value of 1000 millivolts. In some cases, the crest at time point T5 has voltage value of 900 millivolts. On the other hand, in some cases, the crests at time points T2 and T4, which have voltage values of 300 millivolts, each correspond to a reflection caused by a first small clog 421 and a second small clog 422 that are present in a feed pipe, e.g., the feed pipe 110c of FIG. 1.

In other words, a reflection for each clog in the feed pipe is illustrated by the crests received at time points T2 and T4, respectively. The reflection is received by TDR pulse transceiver at time T2 where the time difference (T2-T1) is the propagation time required for the voltage pulse to transmit from an entry point of the feed pipe, e.g., where the feed pipe 110c connects to the blower 112, to reach the first small clog 421 in the feed pipe 110c and then bounce back. This reflection creates the crest at time point T2 as shown in the waveform 420 in FIG. 4B. Similarly, the reflection received at time point T4 corresponds to the second small clog 422 in the feed pipe and creates the crest at time point T4.

In principle the controller can process the round trip travel time of a voltage pulse along the one or more controlled impedance cables to determine the exact location of the clog, e.g., can process the time difference (T2-T1) to determine the exact location of the first small clog 421 in the feed pipe 110c. For example, for a controlled impedance cable of consistent materials, the speed of propagation of a voltage signal can be measured. Using this propagation speed, the exact location of the clog in the feed pipe can be computed.

FIG. 4C depicts another example TDR plot for an abnormal condition of the feeding system. In FIG. 4C, four crests appear at time points T1, T2, T3, and T5, respectively, in the waveform 430. Like FIG. 4B, in some cases, the crest at time point T1 has voltage value of 1000 millivolts. In some cases, the crest at time point T2 has voltage value of 300 millivolts. In some cases, the crest at time point T5 has voltage value of 900 millivolts. However, in some cases, the crest at time point T3 has a voltage value of 800 millivolts. The crest at time point T3 is larger in magnitude than the crest at time point T2 because the reflection corresponding to this crest is caused by a larger clog 432 in the feed pipe 110c than the small clog 431 in the feed pipe that causes the reflection corresponding the crest at time point T2.

Thus, in addition to processing the pulse responses received from the TDR pulse transceiver to determine the corresponding clog locations, the controller can also processes the pulse responses to determine the sizes of the clogs, e.g., relative to other objects or clogs in the feed pipe that cause reflections corresponding to crests in a waveform having known magnitudes.

While the description in this specification largely relates to detecting a clog in the feed pipe, the described techniques can also be used for monitoring the condition of the feed pipe for any of a variety of other abnormalities. For example, a leak in the feed pipe may result in a TDR pattern (e.g., a negative trace in the waveform) indicating the controlled impedance cables are short circuited; and a breakage in the feed pipe may result in a TDR pattern (e.g., a large positive trace in the waveform) indicating the controlled impedance cables are open circuited.

Additionally or alternatively, the described techniques can also be used for determining one or more of: the underwater motion of the feed pipe; the density of feed in the feed pipe; the velocity of the feed moving along the feed pipe; or the estimate of an amount of feed to be delivered to the enclosure.

The underwater motion of the feed pipe can for example be detected by comparing respective snapshots of the TDR measurements across time periods. Changes in the structure and orientation of the pipe will result in subtle changes to the TDR measurements. Large changes could be detected by traditional analysis, and more subtle changes can be detected by machine learning and/or computer vision algorithms.

The density of feed in the feed pipe can for example be detected based on TDR reflection voltages. Usually, higher density of feed will correspond to larger impedance discontinuities and therefore larger TDR reflection voltages (for example, 250 millivolts for higher density of feed vs 200 millivolts for lower density of feed). These techniques can be used to determine the estimated mass of feed at each location along the pipe.

The velocity of the feed moving along the feed pipe refers to the velocities of smaller feed “hotspots” that have higher feed densities. These feed “hotspots” will move along the pipe as feed is blown into the pen, and appropriate algorithms, e.g., machine learning algorithms, can be used by the controller detect and measure the velocity of these feed “hotspots.”

The estimate of an amount of feed to be delivered to the enclosure can for example be detected based on combining the feed density measurements and the feed velocity measurements, e.g., by multiplying density of feed by the velocity of the feed moving along the feed pipe.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. An aquaculture feeding system comprising:
a feed pipe arranged between a dosing system and a fish pen;
a feed pipe monitoring subsystem comprising one or more controlled impedance cables along the feed pipe, and a pulse generator configured to generate a series of pulses at a predetermined pulse rate to be transmitted through the controlled impedance cables; and
a controller subsystem connected to the feed pipe monitoring subsystem, the controller subsystem configured to:
monitor pulse responses along the controlled impedance cables; and
detect, from the pulse responses, a condition of the feed pipe.

2. The aquaculture feeding system of claim 1, wherein detecting the condition of the feed pipe comprises detecting an abnormality in the feed pipe.

3. The aquaculture feeding system of claim 2, wherein detecting the fault in the feed pipe comprises detecting a location or a type of the abnormality in the feed pipe.

4. The aquaculture feeding system of claim 3, wherein the type of the abnormality in the feed pipe comprises a leakage, a clog, or a breakage of the feed pipe.

5. The aquaculture feeding system of claim 1, wherein the pulse generator comprises a Time Domain Reflectometry (TDR) pulse generator that is configured to generate TDR pulses.

6. The aquaculture feeding system of claim 5, wherein monitoring the pulse responses along the controlled impedance cables comprises:
monitoring time domain TDR pulse responses of the controlled impedance cables; and
determining a voltage level change in the time domain TDR pulse responses.

7. The aquaculture feeding system of claim 5, wherein detecting the condition of the feed pipe comprises:
obtaining a first Time Domain Reflectometry (TDR) pattern of the feed pipe; and
detecting the condition by comparing the first TDR pattern with a second TDR pattern that indicates an expected TDR pattern for a feed pipe without any abnormalities.

8. The aquaculture feeding system of claim 1, wherein monitoring the pulse responses along the controlled impedance cables comprises:
performing simultaneous analog-to-digital sampling of the pulse responses.

9. The aquaculture feeding system of claim 1, wherein monitoring the pulse responses along the controlled impedance cables comprises:
performing dynamic spatial resolution modification of the pulse responses.

10. The aquaculture feeding system of claim 1, wherein the one or more controlled impedance cables comprise one or more twin-lead cables.

11. The aquaculture feeding system of claim 1, wherein the controller subsystem is also configured to determine, from the pulse responses, one or more of the following:
underwater motion of the feed pipe;
density of feed in the feed pipe;
velocity of the feed moving along the feed pipe; or
estimate of an amount of feed to be delivered to the enclosure.

12. The aquaculture feeding system of claim 1, wherein the controller subsystem is also configured to transmit a message to the dosing system as a result of detecting the condition.

13. A method, comprising:
generating, by a pulse generator of a feed pipe monitoring subsystem, a series of pulses at a predetermined pulse rate to be transmitted through one or more controlled impedance cables arranged along a feed pipe arranged between a dosing system and a fish pen;
monitoring, by a controller subsystem connected to the feed pipe monitoring subsystem, pulse responses along the controlled impedance cables; and
detecting, by the controller subsystem connected to the feed pipe monitoring subsystem from the pulse responses, a condition of the feed pipe.

14. The method of claim 13, wherein detecting the condition of the feed pipe comprises detecting a fault in the feed pipe.

15. The method of claim 14, wherein detecting the fault in the feed pipe comprises detecting a location or a type of the fault in the feed pipe.

16. The method of claim 15, wherein the type of the fault in the feed pipe comprises a leakage, a clog, or a breakage of the feed pipe.

17. The method of claim 13, wherein the pulse generator comprises a Time Domain Reflectometry (TDR) pulse generator that is configured to generate TDR pulses.

18. The method of claim 17, wherein monitoring the pulse responses along the controlled impedance cables comprises:
monitoring time domain TDR pulse responses of the controlled impedance cables; and
determining a voltage level change in the time domain TDR pulse responses.

19. The method of claim 17, wherein detecting the condition of the feed pipe comprises:
obtaining a first Time Domain Reflectometry (TDR) pattern of the feed pipe; and
detecting the condition by comparing the first TDR pattern with a second TDR pattern that indicates an expected TDR pattern for a feed pipe without any faults.

20. A computer storage medium encoded with a computer program, the program comprising instructions that are operable, when executed by data processing apparatus, to cause the data processing apparatus to perform operations comprising:
generating, by a pulse generator of a feed pipe monitoring subsystem, a series of pulses at a predetermined pulse rate to be transmitted through one or more controlled impedance cables arranged along a feed pipe arranged between a dosing system and a fish pen;
monitoring, by a controller subsystem connected to the feed pipe monitoring subsystem, pulse responses along the controlled impedance cables; and
detecting, by the controller subsystem connected to the feed pipe monitoring subsystem from the pulse responses, a condition of the feed pipe.
